(19) United States
(12) Patent Application Publication
(10) Pub. No.: US 2008/0149148 A1
(43) Pub. Date: Jun. 26, 2008

(54) SUMP OF DISHWASHER

(75) Inventors: Sang Woo Woo, Daegu (KR); Gang Hyun Lee, Changwon-si (KR); Bong Soo Son, Busan (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/861,968

(22) Filed: Sep. 26, 2007

(30) Foreign Application Priority Data
Sep. 27, 2006 (KR) 10-2006-0093860
Sep. 27, 2006 (KR) 10-2006-0093861
Sep. 27, 2006 (KR) 10-2006-0093862

(51) Int. Cl. B08B 13/00

(52) U.S. Cl. 134/104.1; 134/110; 134/198

(57) ABSTRACT

A sump for a dishwasher is provided. The sump includes a sump case, a wash pump assembly, a filtering assembly, and a wash motor. The sump case stores wash liquid. The wash pump assembly pumps wash liquid stored in the sump case. The filtering assembly simultaneously performs filtering of impurities included in pumped wash liquid and guiding a flow of pumped wash liquid. The wash motor drives the wash pump assembly.

The present application claims priority under 35 U.S.C. 119 and 35 U.S.C. 365 to Korean Patent Application No. 10-2006-0093860 (filed on Sep. 27, 2006), 10-2006-0093861 (filed on Sep. 27, 2006) and 10-2006-0093862 (filed on Sep. 27, 2006), which are hereby incorporated by reference in their entirety.

### BACKGROUND

The present disclosure relates to a dishwasher.

Typically, a dishwasher is a household appliance that employs a wash pump to pump wash liquid to be sprayed through spray nozzles toward upper and lower dish racks in order to wash dishes stored on the racks, and dries the dishes afterward. A dishwasher includes a tub that constitutes the basic outer shape of the dishwasher, the above dish racks for storing dishes within the tub, spray arms and nozzles that spray wash liquid onto the surfaces of dishes, and a sump installed at the bottom of the tub to store wash liquid.

Dishwashers according to the related art typically employ a removable residue-collecting filter in the sump for collecting food particles that are removed from dishes during washing, and/or a mechanism that grinds food residue collected in the sump into fine particles to be discharged together with dirty wash liquid during draining.

Sumps installed in dishwashers according to the related art have a plurality of components (assembled using screws or other fasteners), which include a sump case in which wash liquid is stored, a sump cover covering the sump case, the above-described filter for filtering food residue, and a wash pump.

### SUMMARY

Embodiments provide a sump of a dishwasher with an improved assembly configuration of the dishwasher sump, in order to simplify the assembly process.

Embodiments also provide a sump of a dishwasher capable of preventing the leakage of wash liquid while it is being pumped.

Embodiments also provide a sump of a dishwasher capable of minimizing the reduction of pumping pressure during the pumping of wash liquid, by improving the passages through which the wash liquid is pumped by the wash pump.

Embodiments also provide a sump of a dishwasher capable of preventing impurities collected by a filtering unit in the sump from entering the wash pump.

Embodiments also provide a sump of a dishwasher capable of preventing the wash liquid pumped by the wash pump from leaking from around a switching valve.

Embodiments also provide a sump of a dishwasher capable of preventing a portion of wash liquid from leaking while the wash liquid is being pumped, through an improved sealing structure of the wash pump.

Embodiments also provide a sump of a dishwasher with an improved wash pump structure that performs a filtering function of removing impurities from wash liquid, that enables the function of allocating the pumped wash liquid to flow through the water guide or the lower spray arm to be performed within a single component, and that minimizes flow resistance and leakage of wash liquid.

In one embodiment, a sump for a dishwasher includes: a sump case storing wash liquid; a wash pump assembly pumping wash liquid stored in the sump case; a filtering assembly simultaneously performing filtering of impurities included in pumped wash liquid and guiding a flow of pumped wash liquid; and a wash motor driving the wash pump assembly.

In another embodiment, a sump for a dishwasher includes: a sump case; a pump housing mounted within the sump case and including a pump case in which wash liquid is pumped, a valve seat at an outlet of the pump case, and a guide passage enabling wash liquid discharged from the pump case to be divided and flow to a lower spray arm or a water guide; an impeller mounted within the pump case to pump wash liquid; and a vario-valve mounted on the valve seat to determine a flow direction of pumped wash liquid.

In a further embodiment, a sump for a dishwasher includes: a wash pump assembly with a pump case to pump wash liquid; a flow guide including a water guide inlet guiding wash liquid pumped by the wash pump assembly to a water guide, and a lower spray arm inlet guiding pumped wash liquid to a lower spray arm; and a sump cover mounted on top of the flow guide and including a lower spray arm connector open a predetermined diameter at a center of the sump cover, wherein the lower spray arm inlet is curved in a rotating direction of wash water within the pump case.

The details of one or more embodiments are set forth in the accompanying drawings and the description below. Other features will be apparent from the description and drawings, and from the claims.

### BRIEF DESCRIPTION OF THE DRAWINGS

FIG. 1 is a schematic side sectional view of a dishwasher provided with a sump according to the present disclosure.

FIG. 2 is a perspective view of a dishwasher sump according to embodiments of the present disclosure.

FIG. 3 is an exploded perspective view of the sump in FIG. 2.

FIG. 4 is a cutaway sectional view of the sump in FIG. 2 taken along line I-I′.

FIG. 5 is an exploded perspective view of a filtering assembly of a sump according to embodiments of the present disclosure.

FIG. 6 is an exploded perspective view of a self-cleaning filter assembly of a sump according to embodiments of the present disclosure.

FIG. 7 is a bottom view of a sump cover according to embodiments of the present disclosure.

FIG. 8 is a top view of a flow guide according to embodiments of the present disclosure.

FIG. 9 is a bottom view of the flow guide in FIG. 8.

FIG. 10 is an exploded perspective view of a pump housing according to embodiments of the present disclosure.

FIG. 11 is an enlarged view of region A in FIG. 4.

FIG. 12 is a perspective view of a sump case according to embodiments of the present disclosure.

### DETAILED DESCRIPTION OF THE EMBODIMENTS

Reference will now be made in detail to the embodiments of the present disclosure, examples of which are illustrated in the accompanying drawings. It should be understood, however, that the scope of the present disclosure is not limited to embodiments described herein, and that various additions, modifications, and deletions of described elements may easily be proposed for retrogressive inventions and other embodiments that fall within the spirit and scope of the principles of this disclosure.

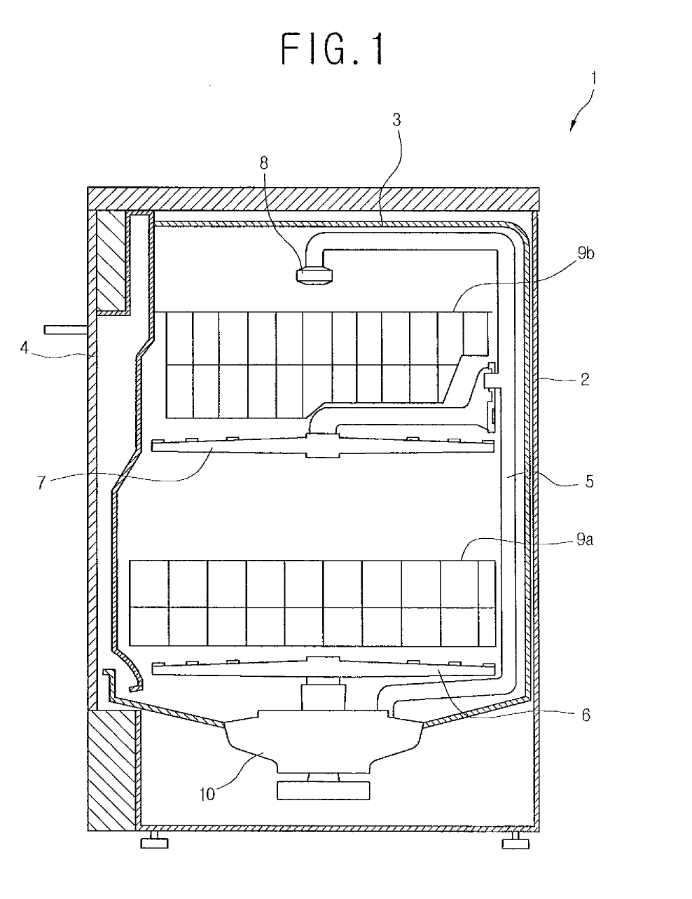

FIG. 1 is a schematic side sectional view of a dishwasher provided with a sump according to the present disclosure.

Referring to FIG. 1, a dishwasher 1 according to embodiments of the present disclosure includes a cabinet 2 constituting an exterior of the dishwasher 1, a door coupled to be capable of pivoting at the front surface of the cabinet 2, a tub 3 provided within the cabinet 2 for storing dishes, dish racks disposed within the tub 3 and capable of entering and exiting the tub 3, a sump 10 for pumping wash liquid that is installed on the floor of the tub 3, a lower spray arm 6 installed on the upper surface of the sump 10 to spray wash liquid, a water guide 5 connected to the sump 10 to guide wash liquid toward the top of the tub 3, a rotating upper spray arm 7 extending from the water guide 5 toward the center of the tub 3, and a top nozzle 8 connected to the top end of the water guide 5 to spray wash liquid.

Specifically, the dish racks include an upper rack 9b disposed above the upper spray arm 7, and a lower rack 9a disposed above the lower spray arm 6.

To provide a brief description on the operation of the above-configured dishwasher 1, a user first opens the door 4 and pulls out the dish racks 9a and 9b to load dirty dishes. Then, after the dish racks 9a and 9b are re-introduced into the tub 3, the door 4 is closed, and a washing course is inputted. When a start button is pressed, wash liquid is supplied into the sump 10. When the wash liquid reaches a preset water level, a wash pump (described below) installed within the sump 10 operates. Wash liquid that is pumped by the wash pump is alternatingly supplied to the lower spray arm 9a and the water guide 5 by means of a vario-valve (described below) installed within the sump 10. Specifically, the wash liquid supplied to the water guide 5 is sprayed into the tub through the upper spray arm 9b and the top nozzle 8.

The wash liquid sprayed through the spray arms/nozzle collides against surfaces of dishes stored in the dish racks, and descends with food deposits and other impurities to the floor of the tub.

A complete washing course of the dishwasher includes a pre-wash cycle in which only wash water (without additives) is sprayed to facilitate the removal of impurities on dishes, a main wash cycle in which wash liquid (wash water mixed with detergent) is sprayed, a rinse cycle for removing residual detergent from dishes following the main wash cycle, and a drying cycle for drying the dishes. The above cycles are performed in order. The pre-wash and drying cycles may be deleted according to users' preferences.

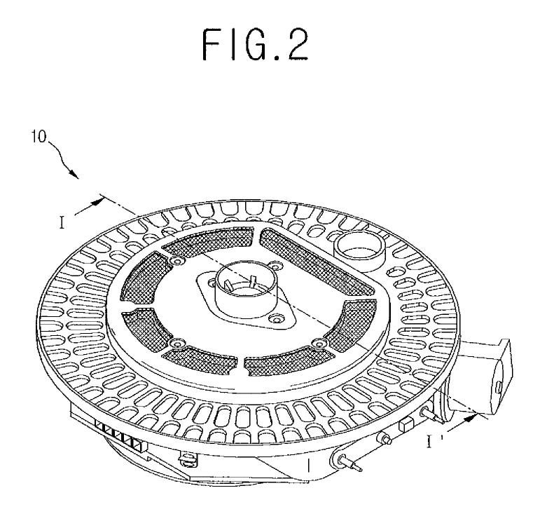

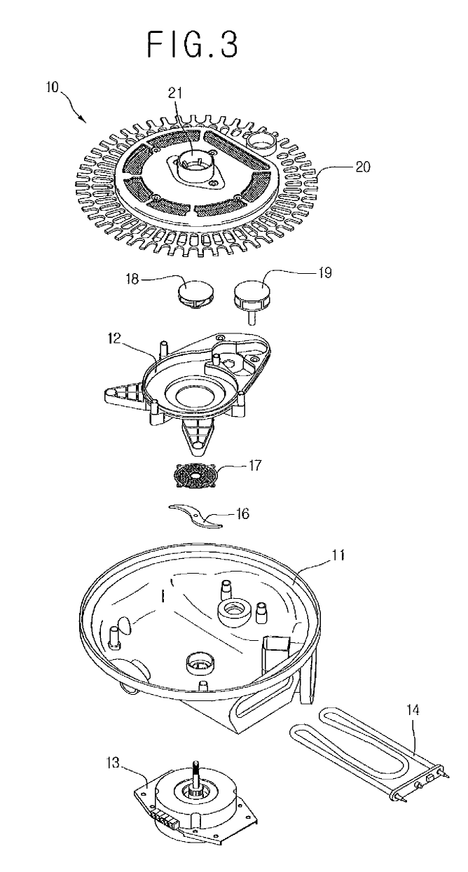

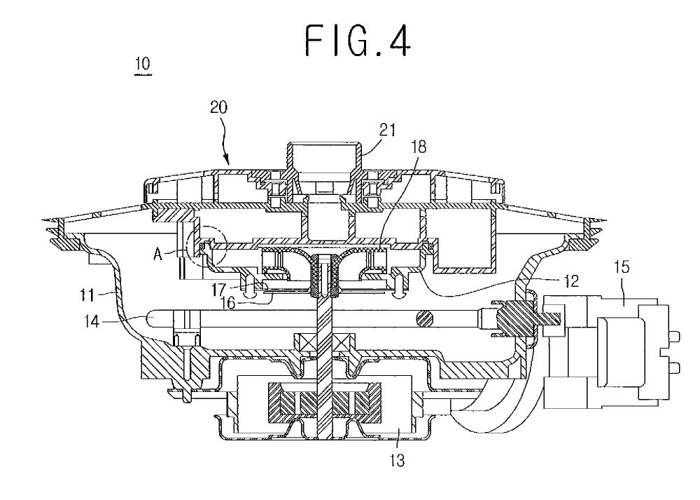

FIG. 2 is a perspective view of a dishwasher sump according to embodiments of the present disclosure, FIG. 3 is an exploded perspective view of the sump in FIG. 2, and FIG. 4 is a cutaway sectional view of the sump in FIG. 2 taken along line I-I′.

Referring to FIGS. 2 to 4, a sump 10 according to embodiments of the present disclosure includes a sump case 11 in which wash liquid is stored, a wash pump assembly that is mounted within the sump case 11 and pumps wash liquid, a filter assembly 20 coupled above the pump assembly, a heater 14 provided within the sump case 11 for heating wash liquid, a wash motor 13 that drives the wash pump assembly, and a drain motor 15 for draining wash liquid stored in the sump case 11.

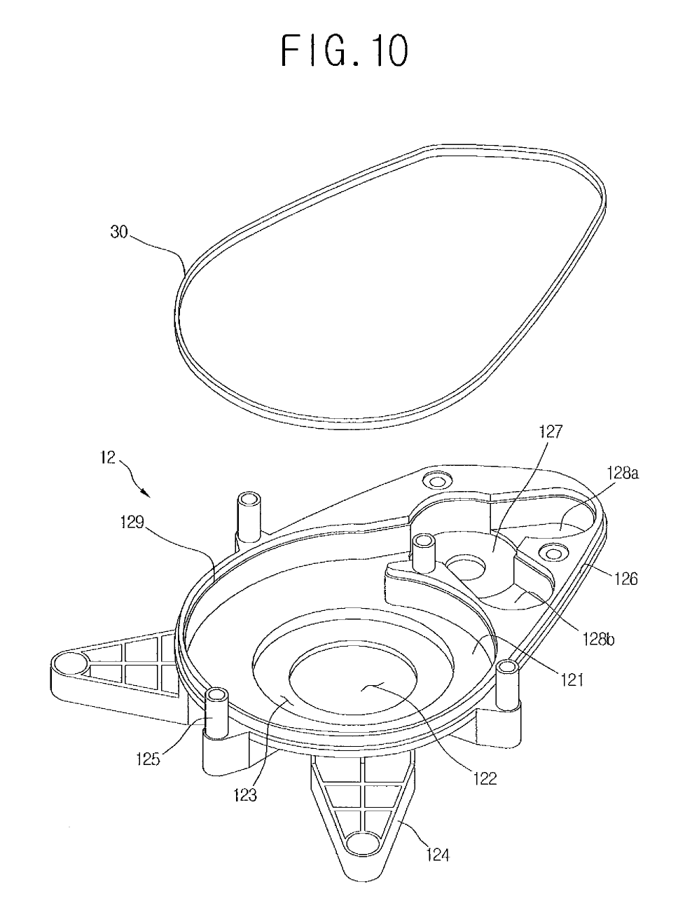

In detail, the wash pump assembly has a pump housing 12 provided with a pump case (121 in FIG. 10) within, and an impeller 18 provided in the pump case to rotate and pump wash liquid. Here, the wash pump for pumping wash liquid is an assembly of the pump case 121 coupled with the impeller 18.

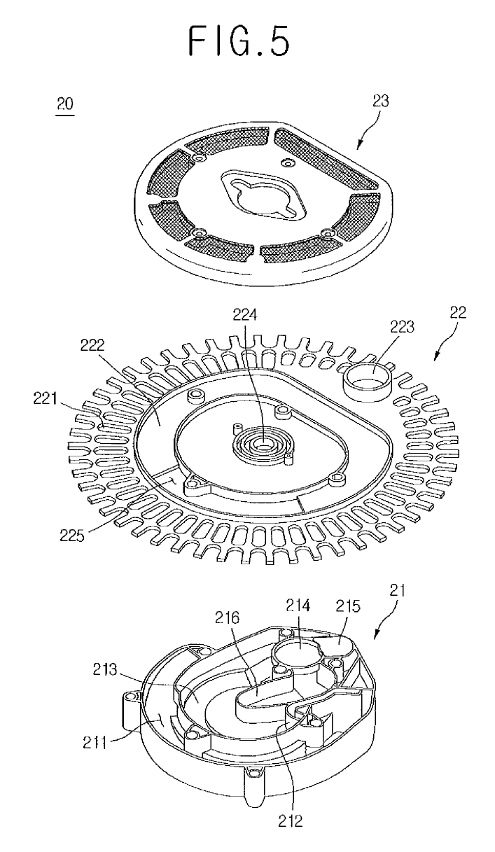

In further detail, a nozzle neck 21 is coupled to the upper surface at the center of the filtering assembly 20 to mount the lower spray arm thereon. Also, a water guide connector (223 in FIG. 5) is provided on an end at an edge of the filtering assembly 20 to couple the water guide 5.

A screen filter 17 is coupled to the undersurface of the pump housing 12 to filter impurities in a primary filtering stage when wash liquid is suctioned by the wash pump. Also, a disposer 16 is installed below the screen filter 17 to finely grind the impurities in the suctioned wash liquid. Here, the disposer 16 is connected to the shaft of the wash motor. Thus, the impeller 18 and the disposer 16 rotate together with the motor shaft.

The above-configured sump 10 includes the sump case 11, wash pump assembly, and filter assembly 20 shown in FIGS. 2 to 4. The filter assembly 20 is integrally formed through thermal bonding with a flow guide having a collecting filter, sump cover, and soil chamber. A detailed description thereof will be provided below with reference to the diagrams.

FIG. 5 is an exploded perspective view of a filter assembly of a sump according to embodiments of the present disclosure.

Referring to FIG. 5, a filter assembly 20 according to embodiments of the present disclosure includes a flow guide 21 providing passages that divide the flow of wash liquid pumped by the wash pump to the lower spray arm and the water guide, a sump cover 22 thermally bonded and coupled to the top surface of the flow guide 21, and a collecting filter 23 thermally bonded and coupled to the top surface of the sump cover 22.

Specifically, a soil chamber 211 of a predetermined length is formed in the outer portion of the flow guide 21 to collect impurities during the wash cycle. The drain pump is connected to one end of the soil chamber 211. Accordingly, collected impurities are discharged to the outside together with wash liquid during a draining process. The soil chamber 211 is sloped downward toward its end that is connected to the drain pump, enabling impurities to be completely discharged during the draining process.

A pump case cover 213 is provided inward of the soil chamber 211, and the pump case 213 covers and seals the top of the pump case (121 in FIG. 10) formed in the pump housing. A vario-valve cover 214 is formed at the end of the pump case cover 213, and a water guide inlet 215 and a lower spray arm inlet 216 are respectively formed to extend from the vario-valve cover 214. That is, the lower spray arm inlet 216 is formed along the upper surface of the pump case cover 213.

A sampling passage 212 is formed at an edge of one end of the pump case cover 213 and has an end connected to the drain pump. Specifically, the sampling passage 212 communicates with the pump case 121, and a portion of the pumped wash liquid is divided and flows therethrough. The wash liquid that flows along the sampling passage 212 collects at the drain pump. When the drain pump does not operate, the wash liquid flows back toward the soil chamber 211.

A plurality of water drain holes 221 are arranged at a uniform distance apart in the outer peripheral portion of the sump cover 22 that is thermally bonded to the top surface of the flow guide 21, and communicate with the sump case 11. That is, the sprayed wash liquid passes through the water drain holes 221 together with impurities, and collects in the sump case 11.

A divider 222 is formed inward of the water drain holes 221, and a reverse flow hole 225 defines an open portion of the divider 222. The lower spray arm connector 224 is formed at the center of the sump cover 22, and the lower spray arm connector 224 communicates with the lower spray arm inlet 216 of the flow guide 21. Accordingly, wash liquid that flows through the lower spray arm inlet 216 is guided to the lower spray arm through the lower spray arm connector 224.

A water guide connector 223 is formed at an edge of the sump cover 22, and the water guide connector 223 communicates with a water guide inlet 215 of the flow guide 21. Thus, wash liquid flowing through the water guide inlet 215 is guided through the water guide connector 223 to the water guide.

The collecting filter 23 is thermally bonded and integrally formed at the upper surface of the sump cover 22.

In detail, a mesh for filtering impurities contained in wash liquid is formed around the perimeter within the collecting filter 23. The structure of the collecting filter 23 will be described in detail below, with reference to the drawings.

In the above configuration, wash liquid that is pumped by the wash pump is alternatingly supplied to the water guide inlet 215 formed in the flow guide 21 according to the location of the vario-valve, and to the lower spray arm inlet 216. A portion of wash liquid pumped by the wash pump is divided according into the sampling passage 212 and descends toward the drain pump. When the drain pump is not operating, the wash liquid that descends flows backward into the soil chamber 211.

In more detail, when wash liquid completely fills the soil chamber 211, the wash liquid flows backward through the reverse flow hole 225 of the sump cover 22. The wash liquid that flows in a reverse direction passes through the water drain holes 221 and collects within the sump case 11. Here, the wash liquid that flows in a reverse direction through the reverse flow hole 225 also flows toward the top of the divider 222. The wash liquid also passes through the mesh around the collecting filter 23 and is removed of impurities, so that only wash liquid passes through the water drain holes 221 and collects within the sump case 11. Here, the divider 222 is slightly recessed toward the reverse flow hole 225, enabling the removed impurities to collect in the soil chamber 211.

The above process is repeated during a wash course so that impurities are collected in the soil chamber 211, and the collected impurities are discharged to the outside through a draining process.

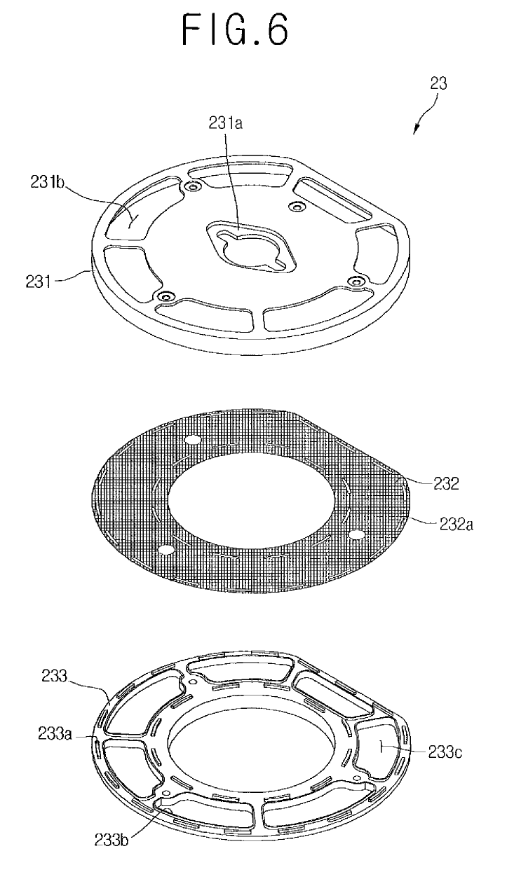

FIG. 6 is an exploded perspective view of a self-cleaning filter assembly of a sump according to embodiments of the present disclosure.

Referring to FIG. 6, the collecting filter 23 according to embodiments of the present disclosure includes a mesh 232 with a dense array of miniature holes, a lower cover 233 provided below the mesh 232, and an upper cover 231 provided above the mesh 232.

Specifically, the lower cover 233 is coupled through thermal bonding to the upper cover 231, and the mesh 232 is fixed between the upper cover 231 and the lower cover 233 by means of the thermal bonding process.

A plurality of through-holes 231b is formed within the upper cover 231, and a nozzle neck seat 231a is formed in the central portion of the upper cover 231. A through hole is formed within the nozzle neck seat 231a to allow wash liquid to flow into the lower spray arm.

Through-holes in the same configuration as the through-holes 231b are formed in the lower cover 233, and a plurality of mesh fixing ribs 233a and fusing portions 233b are formed along inner and outer edges of the lower cover 233.

The mesh 232 has holes formed along in its inner and outer edges for the mesh fixing ribs 233a to pass through.

In detail, the mesh fixing ribs 233a formed on the upper surface of the lower cover 233 pass through the mesh 232 and press against the undersurface of the upper cover 231. Then, with the upper cover 231 and the lower cover 233 pressed firmly together, heat is applied to fuse and couple the two pieces. Through this thermal bonding, the mesh 232 is stretched taut.

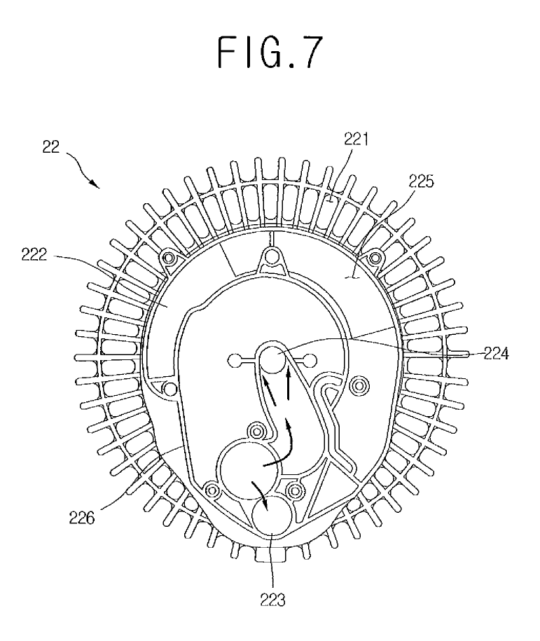

FIG. 7 is a bottom view of a sump cover according to embodiments of the present disclosure.

Referring to FIG. 7, a fusing rib 226 is provided on the undersurface of the sump cover 22 to enable the latter to be coupled through thermal bonding to the flow guide 21. That is, the shape of the fusing rib 226 is formed to correspond to the shape of the top surface of the flow guide 21, in order to completely seal the internal space of the flow guide. Accordingly, tops of the lower spray arm inlet 216 formed on the flow guide 21, the water guide inlet 215, and the sampling passage 212 are completely sealed. Thus, wash liquid disposed in each respective space does not leak into other spaces. Also the reverse flow hole 225 is defined in the upper portion of the soil chamber 211, so that the wash liquid supplied to the soil chamber 211 flows backward through the reverse flow hole 225, and does not leak to the lower spray arm inlet 216 or the water guide inlet 215.

Moreover, because the end of the lower spray arm inlet 216 communicates with the lower spray arm connector 224 of the sump cover 22, the end of the water guide inlet 215 communicates with the water guide connector 223.

At least a portion of the inner circumference of the lower spray arm connector 224 formed at the center of the sump cover 22 has a surface corresponding to the inner circumference of the end of the lower spray arm inlet 216 formed on the flow guide 21. That is, a portion of the lower spray arm connector 224 is curved at the same curvature as the end of the lower spray arm inlet 216. Also, the circumference of the portion of the lower spray arm connector 224 with the same curvature as the end of the lower spray arm inlet 216 can be completely sealed against the end of the lower spray arm inlet 216.

By sealing the lower spray arm connector 224 to the end of the lower spray arm inlet 216 as described above, the pressure of the wash liquid pumped to the lower spray arm inlet 216 can be prevented from dropping.

If the lower spray arm connector 224 were to be disposed apart from the end of the lower spray arm inlet 216, the wash liquid pumped to the lower spray arm inlet 216 would be unable to rise in its entirety toward the lower spray arm.

In other words, the wash liquid pumped toward the lower spray arm inlet 216 would flow through the space formed between the outer circumference of the lower spray arm connector 224 and the end portion of the lower spray arm inlet 216, forming a rotating current. This rotating wash liquid is switched to flow back toward the valve. Thus, the wash liquid supplied to the lower spray arm inlet 216 and the wash liquid flowing in a reverse direction due to the rotating current collide to form turbulence. As a result, flow resistance is generated near the lower spray arm connector 224, causing a sudden rise in the pressure of the wash liquid.

To prevent the above from occurring, the lower spray arm connector 224 may be completely sealed against the end of the lower spray arm inlet 216.

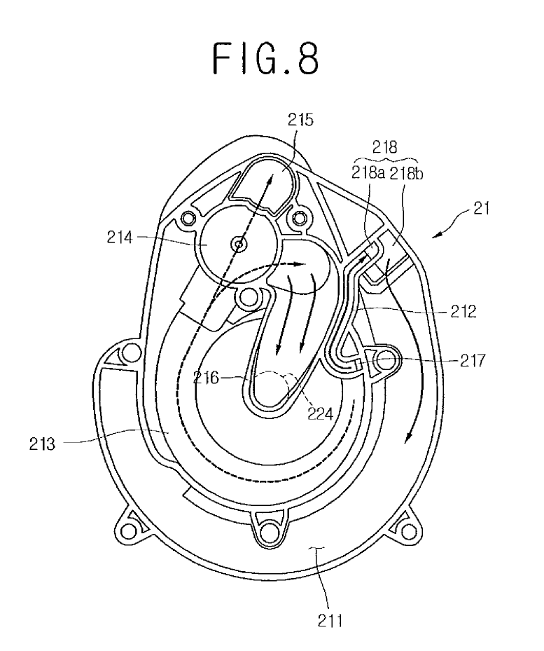

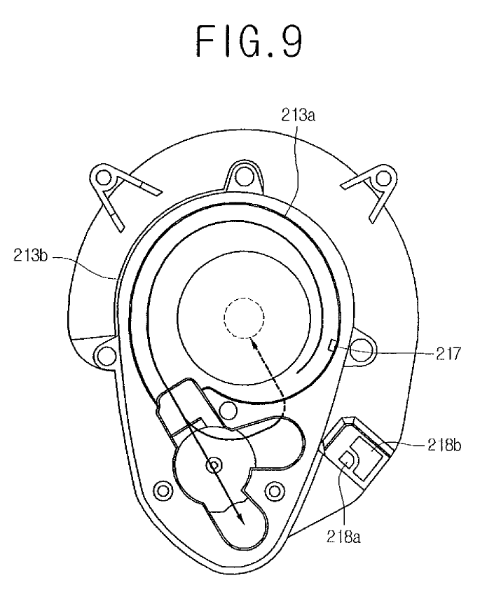

FIG. 8 is a top view of a flow guide according to embodiments of the present disclosure, and FIG. 9 is a bottom view of the flow guide in FIG. 8.

Referring to FIGS. 8 and 9, a soil chamber 211 of a predetermined length is provided at the perimeter of the flow guide 21, and a pump case cover 213 is formed to the inside thereof. In detail, a voluted rib 213a is formed on the undersurface of the pump case cover 213, and covers the inner perimeter of the pump case 121 formed on the pump housing 12. Also, a sealer pressing rib 213b is formed to the outside of the voluted rib 213 in accordance with the shape of the pump housing 12.

In further detail, the sealer pressing rib 213b laterally presses a sealer 30 (in FIG. 10) disposed around the outer perimeter of the pump housing 12.

According to the related art, a sealing member around the pump housing 12 is generally configured to receive pressure in a downward direction by a component seated on top of the pump housing. Here, when the coupling of the pump housing 12 and the component seated on top of the pump housing 12 is weak, a tight seal cannot be maintained by the sealing member, so that wash id leaks.

However, according to embodiments of the present disclosure, because the sealer 30 receives horizontal and not vertical pressure, leakage of wash liquid can be obviated.

Wash liquid is pumped by the wash pump below the flow guide and supplied to the respective spray arms and nozzles.

Specifically, wash liquid pumped by the wash pump rotates in a voluted shape within the wash pump and is discharged. Also, a vario-valve is disposed at the outlet of the wash pump to alternatingly supply the pumped wash liquid to the lower spray arm and the water guide.

More specifically, a vario-valve cover 214 supporting the upper surface of the vario-valve is formed on the flow guide 21, and the water guide inlet 215 and the lower spray arm inlet 216 extend from the vario-valve cover 214. The water guide inlet 215 is substantially the same in direction as the flow of wash liquid discharged by the wash pump. This is to minimize flow loss when the wash liquid discharged from the wash pump passes through the vario-valve.

The lower spray arm inlet 216 is also curved in the same direction as that of the rotating wash liquid within the wash pump, and is connected to the center of the flow guide 21.

As shown in FIG. 8, wash liquid rotates within the wash pump in the direction designated by the arrows, and is discharged. Also, the wash liquid guided to the water guide extends in a substantial straight line from the outlet of the wash pump. In addition, wash liquid guided toward the lower spray arm flows along the lower spray arm inlet 216 curved in the same direction as the flow of wash liquid within the wash pump. In this flow configuration, while the direction of flow of wash liquid is switched by the vario-valve, flow loss caused by passage structure can be minimized.

Also, the inner circumference of the lower spray arm 224 formed at the center of the sump cover 22 is formed at a coinciding position (in a plan view) to the inner circumference of the end portion of the lower spray arm inlet 216. The reason for this is the same as that already described.

A sampling hole 217 is formed at one edge of the pump case cover 213 that formed the flow guide 21. In detail, the pump case cover 213 covers the pump case 121 formed to the inside of the pump housing 12. Accordingly, a portion of the wash liquid rotating within the pump case 121 rises through the sampling hole 217, and flows along the sampling passage 212.

The end of the sampling passage 212 communicates with a drain pump connector 218.

In detail, the drain pump connector extends a predetermined length downward from the flow guide 21, and is connected to the drain pump case. The drain pump connector 218 is separated within by a divider into a drain hole 218a and a reverse flow hole 218b. The end of the sampling passage 212 is connected to the drain hole 218a, and the end of the soil chamber 211 is connected to the reverse flow hole 218b.

In the above configuration, wash liquid separated by the sampling passage 212 descends through the drain hole 218a to the drain pump. When the drain pump is not operating, the wash liquid that descends onto the drain pump flows through the reverse flow hole 218b in a reverse direction to the soil chamber 211.

Here, the end of the soil chamber 211 at the reverse flow hole 218b is formed lower than the opposite end, so that impurities and wash liquid remaining in the soil chamber can be discharged together in a draining process.

FIG. 10 is an exploded perspective view of a pump housing according to embodiments of the present disclosure.

Referring to FIG. 10, according to embodiments of the present disclosure, the pump housing 12 is mounted within the sump case 11 and fixed by means of screws or other fastening members.

In detail, a plurality of fixing legs 124 that are fixed to the sump case 11 extend from one side of the outer circumference of the pump housing 12. A hole is formed in the end of the fixing leg 124 to insert a fixing boss therein. Also, a flow guide fixing boss 125 extends upward from the outer circumference of the pump housing 12, and inserts into the flow guide 21. A fixing member that inserts into the flow guide fixing boss 125 firmly fastens the pump housing 12 to the undersurface of the flow guide 21. The pump case 121 is formed in a voluted shape within the pump housing 12, and a suctioning hole 122 for suctioning wash liquid is formed in the center thereof. The screen filter 17 (in FIG. 3) is coupled to the lower end of the suctioning hole 122, to allow wash liquid that has been filtered of impurities in a primary stage to flow into the pump case 121.

A vario-valve seat 127, on which the vario-valve 19 (in FIG. 3) is mounted, is formed at the outlet of the pump case 121. A water guide inlet passage 128a and a lower spray arm inlet passage 128b respectively extend from the vario-valve seat 127. Here, the water guide inlet passage 128a extends in a substantially aligned direction with the outlet of the pump case 121, and the lower spray arm inlet passage 128b is curved in the same direction as the rotating direction of wash liquid within the pump case 121.

A sealer seat 126, on which a sealer 30 is seated, is formed at the outer perimeter of the pump housing 12. A voluted rib seat 129 is formed at a stepped recess of a predetermined depth in a single unbroken line along the upper perimeters of the pump case 121, vario-valve seat 127, water guide inlet passage 128a, and lower spray arm inlet passage 128b.

The floor of the pump case 121 and the floor at the outlet of the pump case 121 share the same horizontal surface, allowing the pressure of wash liquid discharged from the pump case to remain the same. According to the related art, the floor of at the outlet of the pump case 121 is inclined higher than the floor of the pump case 121, so that the input pressure of the wash liquid is reduced.

The vario-valve 19 is provided within the pump housing 12 with the pump case 121, preventing wash liquid from leaking around the vario-valve 19. That is, only a through-hole for the vario-valve shaft to pass through is formed in the floor of the vario-valve seat 127, and outlet of the pump case 121, the water guide inlet passage 128a, and the lower spray arm inlet passage 128b are formed integrally with the vario-valve seat 127. As a result, when wash liquid discharged from the pump case 121 is guided to the water guide inlet passage 128a or the lower spray arm inlet passage 128b, it will not leak along the outer perimeter of the vario-valve 19.

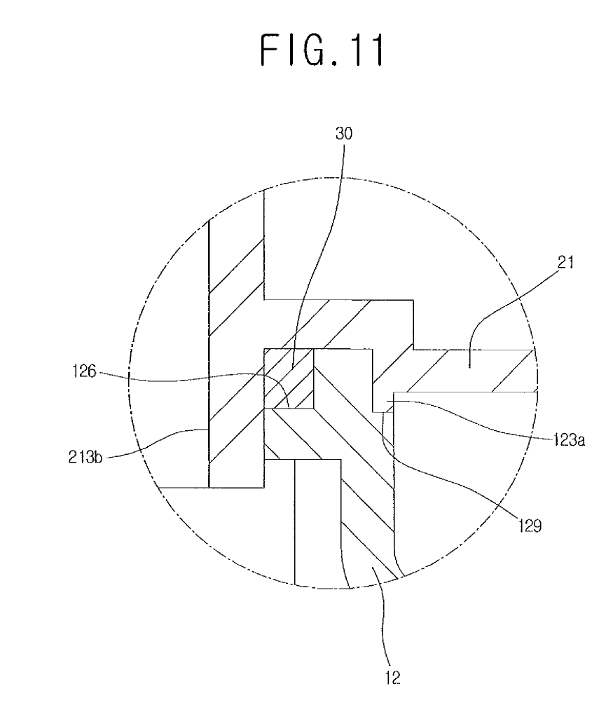

FIG. 11 is an enlarged view of region A in FIG. 4.

Referring to FIG. 11, the sealer seat 126 is formed stepped into the outer perimeter of the pump housing 12. A sealer pressing rib 213b extending from the bottom of the flow guide 21 presses against the outer surface of the pump housing 12 A sealer 30 is inserted in the space between the sealer pressing rib 213b and the sealer seat 126.

A voluted rib seat 129 is stepped at the inner perimeter surface of the pump case 121. The voluted rib 213a that protrudes at the lower surface of the flow guide 21 is seated on the voluted rib seat 129. Here, of course, a separate sealing member may be inserted between the voluted rib 213a and the voluted rib seat 129. The voluted rib 213a presses against either the inner or top surface of the sealing member seated on the voluted rib seat 129, to prevent wash liquid from leaking to the outside.

As described above, when the sealer 30 is disposed around the outer perimeter of the pump housing 12 and has its top and outer surfaces pressed by the sealer pressing rib 213b, wash liquid that rotates within the pump case 121 is prevented from leaking to the outside.

In detail, the wash liquid within the pump case 121 is prevented from leaking by the sealer pressing rib 213b in a first stage. Also, it is prevented from leaking in a second stage by the sealer 30. If the sealer 30 were to be seated on the top surface of the pump housing 12, there would be a large possibility of wash liquid leaking through gaps formed between coupling surfaces of the sealer 30 and pump housing 12, and between coupling surfaces of the sealer 30 and flow guide 21.

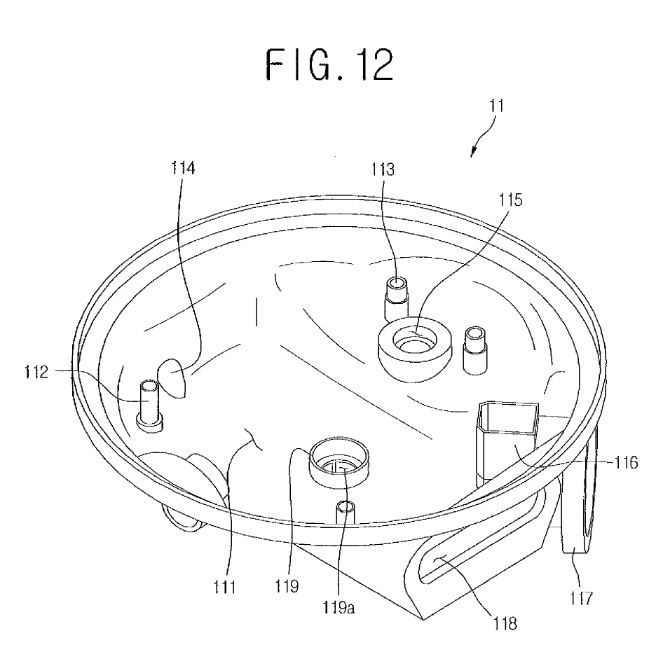

FIG. 12 is a perspective view of a sump case according to embodiments of the present disclosure.

Referring to FIG. 12, a reservoir 111 for storing wash liquid wash liquid is formed within the sump case 11, according to embodiments of the present disclosure.

A first fixing boss 112 and a second fixing boss 113, for fixing the pump housing 12, protrude from an inner surface of the sump case 11. Specifically, the first fixing boss 112 passes through the fixing leg 124 of the pump housing 12, and the second fixing boss 113 couples to the undersurface of the pump housing 12 at the other side to the fixing leg 124.

A motor shaft through-hole 119a, through which the motor shaft of the wash motor passes, is formed in the floor of the sump case 11, and a cylindrical motor sealer seat 119 extends from around the motor shaft through-hole 119a. A round sealing member is inserted inside the motor sealer seat 119 to prevent leakage of wash liquid from around the motor shaft.

A water supply hole 114 is formed in a side of the sump case 11, and a drain pump case 117 is provided on the other side. Specifically, a drain impeller is held within the drain pump case 117 and is connected to the drain motor 15 (refer to the drain motor in FIG. 4).

A heater insert hole 118 to pass the heater 14 through is formed in another side of the sump case 11. A vario-valve shaft through-hole 115 is formed in a portion of the floor of the sump case 11. Therefore, the shaft of the vario-valve 19 passes through the sump case 11 and is connected to a vario-valve motor mounted to the undersurface of the sump case 11.

A drain guide 116 is provided at the inner portion of the sump case 11 where the drain pump case 117 is formed.

That is, the drain pump connector 218 (FIG. 8) extending from the floor of the flow guide 21 inserts into the drain guide 116. Accordingly, the wash liquid descending through the drain hole 218a of the drain pump connector 218 is guided by the drain guide 116 to the drain pump case 117. When the drain pump does not operate, wash liquid that collects in the drain pump case 117 flows in a reverse direction along the drain guide 116. The wash liquid moves through the reverse flow hole 218b of the drain pump connector 218 to the soil chamber 211. A drain hole (not shown) is formed in the lower end of the drain guide 116 and communicates with the reservoir 111 of the sump case 11. A check valve is installed on the drain hole to prevent wash liquid that collects in the drain pump case 117 from flowing backward into the reservoir 11.

When draining begins, wash liquid and impurities stored in the reservoir 111 and soil chamber 211 simultaneously flow through the drain guide 116 to the drain pump case 117. The dirty wash liquid is discharged to the outside through the operation of the drain impeller.

What is claimed is:

1. A sump for a dishwasher, comprising:
a sump case storing wash liquid;
a wash pump assembly pumping wash liquid stored in the sump case;
a filtering assembly simultaneously performing filtering of impurities included in pumped wash liquid and guiding a flow of pumped wash liquid; and
a wash motor driving the wash pump assembly.

2. The sump according to claim 1, wherein the filtering assembly comprises:
a pump case cover covering an upper portion of the wash pump assembly to generate pumping pressure;
a flow guide including a sampling passage with one end communicating with a perimeter at a side of the pump case cover to divide a portion of wash liquid, and a soil chamber surrounding an outside of the pump case cover and communicating with the other end of the sampling passage, to collect impurities;
a sump cover provided above the flow guide, and including a reverse flow hole enabling wash liquid stored in the soil chamber to flow backward; and
a self cleaning filter above the sump cover, to remove impurities from wash liquid that flows backward through the reverse flow hole.

3. The sump according to claim 2, wherein a portion at which the sampling passage and the soil chamber communicate is connected to a drain pump.

4. The sump according to claim 2, wherein the sampling passage comprises a sampling hole at one end thereof, the sampling hole directly communicating the pump case of the wash pump assembly with the sampling passage.

5. The sump according to claim 2, wherein the flow guide comprises a guide portion guiding a flow of wash liquid pumped by the wash pump assembly to a water guide or a lower spray arm.

6. The sump according to claim 2, wherein
a portion of wash liquid pumped by the wash pump assembly flows along the sampling passage to the soil chamber,
wash liquid flowing to the soil chamber flows backwards through the reverse flow hole and is removed of impurities while passing through the collecting filter, and
wash liquid that passes through the collecting filter passes through water drain holes formed in the sump cover and re-enters the sump case.

7. The sump according to claim 2, wherein the collecting filter, the sump cover, and the flow guide are integrally combined through thermal bonding.

8. The sump according to claim 1, wherein the wash pump assembly is coupled to an undersurface of the filtering assembly through a separate fastening member.

9. A sump for a dishwasher, comprising:
a sump case;
a pump housing mounted within the sump case and including a pump case in which wash liquid is pumped, a valve seat formed at an outlet of the pump case, and a guide passage enabling wash liquid discharged from the pump case to be divided and flow to a lower spray arm or a water guide;
an impeller mounted within the pump case to pump wash liquid; and
a vario-valve mounted on the valve seat to determine a flow direction of pumped wash liquid.

10. The sump according to claim 9, wherein the guide passage comprises:
a water guide inlet enabling wash liquid to flow to the water guide; and
a lower spray arm inlet enabling wash liquid to flow to the lower spray arm,
wherein the guide passage extends from the valve seat.

11. The sump according to claim 10, wherein
the water guide inlet is aligned with the outlet of the pump case, and
the lower spray arm inlet is curved in a rotating direction of the impeller.

12. The sump according to claim 9, wherein a floor at an outlet connecting the pump case and the valve seat is flat.

13. The sump according to claim 9, further comprising:
a plurality of fixing legs extending a predetermined distance from an outer perimeter of the pump housing, and mounted to the sump case; and
a fixing boss protruding upward on the sump case, and passing through an end of the fixing leg.

14. The sump according to claim 9, wherein the pump housing comprises a sealer seat on an outer surface thereof, to encircle a sealing member thereon.

15. A sump for a dishwasher, comprising:
a wash pump assembly with a pump case to pump wash liquid;
a flow guide including a water guide inlet guiding wash liquid pumped by the wash pump assembly to a water guide, and a lower spray arm inlet guiding pumped wash liquid to a lower spray arm; and
a sump cover mounted on top of the flow guide and including a lower spray arm connector open a predetermined diameter at a center of the sump cover,
wherein the lower spray arm inlet is curved in a rotating direction of wash water within the pump case.

16. The sump according to claim 15, wherein the lower spray arm inlet extends from an outlet of the pump case to a middle of the flow guide, and
a vario-valve is provided between the outlet of the pump case and an entrance of the lower spray arm inlet.

17. The sump according to claim 15, wherein the lower spray arm connector is disposed directly over an end of the lower spray arm inlet.

18. The sump according to claim 15, wherein at least a portion of an inner surface of the lower spray arm connector is formed integrally with an inner surface at an end of the lower spray arm inlet.

19. The sump according to claim 15, wherein
a portion of the lower spray arm connector is formed with the same rate of curvature as an end of the lower spray arm inlet, and
the portion of the lower spray arm connector with the same rate of curvature as the end of the lower spray arm inlet entirely contacts the end of the lower spray arm inlet.

20. The sump according to claim 15, further comprising:
a pump case cover provided at an inside of the flow guide and covering an upper opening of the sump case,
wherein the lower spray arm inlet extends along an upper surface of the pump case cover.

21. The sump according to claim 15, wherein the water guide inlet is substantially aligned with a direction in which wash liquid is discharged through an outlet of the pump case.
